(19) United States
(12) Patent Application Publication
(10) Pub. No.: US 2018/0161945 A1
(43) Pub. Date: Jun. 14, 2018

(54) BOLT FASTENING APPARATUS

(71) Applicants: Hyundai Motor Company, Seoul (KR); Kia Motors Corporation, Seoul (KR)

(72) Inventor: Hyunseok JANG, Daegu (KR)

(73) Assignees: Hyundai Motor Company, Seoul (KR); Kia Motors Corporation, Seoul (KR)

(21) Appl. No.: 15/664,337

(22) Filed: Jul. 31, 2017

(30) Foreign Application Priority Data
Dec. 12, 2016 (KR) 10-2016-0168894

(51) Int. Cl. B23P 19/06; B25B 17/00

(52) U.S. Cl. CPC B23P 19/069; B25B 17/00

(57) ABSTRACT

A bolt fastening apparatus may include a torque input shaft into; a first differential drive shaft connected to the torque input shaft by a bevel gear structure; a second differential drive shaft connected to the first differential drive shaft by a bevel gear structure; a first transfer gear connected to the second differential drive shaft by a gear engagement; a first fastening portion connected to a bolt to engage the bolt by integrally rotating together with the first transfer gear; a first differential driven shaft connected to the first differential drive shaft by a differential gear structure; a third differential drive shaft connected to the first differential driven shaft by a bevel gear structure; a second transfer gear connected to the third differential drive shaft by a gear engagement; and a second fastening portion connected to a bolt to engage the bolt by integrally rotating together with the second transfer gear.

### CROSS-REFERENCE(S) TO RELATED APPLICATIONS

The present application claims priority to Korean Patent Application No. 10-2016-0168894 filed on Dec. 12, 2016, the entire contents of which are incorporated herein for all purposes by this reference.

### BACKGROUND OF THE INVENTION

### Field of the Invention

The present invention relates to a bolt fastening apparatus. More particularly, the present invention relates to a bolt fastening apparatus applying a structure of a differential gear.

### Description of Related Art

Generally, a differential gear is a device for transferring a driving torque between an axle shaft connected with a driving wheel and a transmission.

The differential gear adjusts the rotation speeds of an inside driving wheel and an outside driving wheel in a vehicle which turns wherein a rotation speed of the inside driving wheel and a rotation speed of the outside driving wheel are different, and thus, achieves that the inside driving wheel and the outside driving wheel don't receive immoderate load and the vehicle is smoothly driven.

Meanwhile, techniques for solving problems occurred in the present case of respectively fastening at least two bolts which must be uniformly engaged are needed. A fastening apparatus by which air pressure is distributed for fastening at least two bolts wherein at least two bolts are simultaneously engaged is used as one of the techniques.

However, using of the conventional fastening apparatus may be limited in a work site where it is impossible to provide sufficient air pressure for generating a torque demanded to engage a bolt. Further, when the conventional fastening apparatus is used, deviation of torques according to non-uniform air pressure distribution may occur, engage deviation among the at least two bolts and generate a problem including bolt release.

The information disclosed in this Background of the Invention section is only for enhancement of understanding of the background of the invention and should not be taken as an acknowledgement or any form of suggestion that this information forms the prior art already known to a person skilled in the art.

### BRIEF SUMMARY

The present invention is directed to providing a bolt fastening apparatus having the advantage of simultaneously fastening at least two bolts without fail.

A bolt fastening apparatus according to an exemplary embodiment of the present invention may include a torque input shaft into which a torque is inputted; a first differential drive shaft connected to the torque input shaft by a bevel gear structure; a second differential drive shaft connected to the first differential drive shaft by a bevel gear structure; a first transfer gear connected to the second differential drive shaft by gear engagement; a first fastening portion connected to a bolt to engage the bolt by integrally rotating together with the first transfer gear; a first differential driven shaft connected to the first differential drive shaft by a differential gear structure; a third differential drive shaft connected to the first differential driven shaft by a bevel gear structure; a second transfer gear connected to the third differential drive shaft by gear engagement; and a second fastening portion connected to a bolt to engage the bolt by integrally rotating together with the second transfer gear.

The bolt fastening apparatus may further include: a second differential driven shaft connected to the second differential drive shaft by a differential gear structure; a third transfer gear connected to the second differential driven shaft by gear engagement; a third fastening portion concentrically disposed with the third transfer gear and connected to a bolt to engage the bolt; and a first reverse gear connected to the third transfer gear and the third fastening portion by a bevel gear structure.

The bolt fastening apparatus may further include: a third differential driven shaft connected to the third differential drive shaft by a differential gear structure; a fourth transfer gear connected to the third differential driven shaft by gear engagement; a fourth fastening portion concentrically disposed with the fourth transfer gear and connected to a bolt to engage the bolt; and a second reverse gear connected to the fourth transfer gear and the fourth fastening portion by a bevel gear structure.

The torque input shaft, the first differential drive shaft, the first differential driven shaft, the second differential drive shaft, the first transfer gear, the third differential drive shaft, the second transfer gear, the second differential driven shaft, the third transfer gear, the first reverse gear, the third differential driven shaft, the fourth transfer gear, and the second reverse gear may be provided in a gear box.

The bolt fastening apparatus may further include a torque input portion disposed external of the gear box to input a torque into the torque input shaft.

A bolt fastening apparatus according to an exemplary embodiment of the present invention may include: a torque input shaft into which a torque is inputted; a first differential drive shaft connected to the torque input shaft by gear engagement; a second differential drive shaft connected to the first differential drive shaft by gear engagement; a first transfer gear connected to the second differential drive shaft by gear engagement; a first fastening portion rotating together with the first transfer gear to engage a bolt; a first differential driven shaft dependently rotating by the rotation of the first differential drive shaft; a first differential gear connecting the first differential drive shaft with the first differential driven shaft by a differential gear structure; a third differential drive shaft connected to the first differential driven shaft by gear engagement; a second transfer gear connected to the third differential drive shaft by gear engagement; and a second fastening portion rotating together with the second transfer gear to engage a bolt.

The bolt fastening apparatus may further include: a second differential driven shaft dependently rotating by the rotation of the second differential drive shaft; a second differential gear connecting the second differential drive shaft with the second differential driven shaft by a differential gear structure; a third transfer gear connected to the second differential driven shaft by gear engagement; a first reverse gear connected to the third transfer gear by gear engagement; and a third fastening portion concentrically disposed with the third transfer gear and being connected to the first reverse gear by gear engagement, rotating to engage a bolt.

The bolt fastening apparatus may further include: a third differential driven shaft dependently rotating by the rotation of the third differential drive shaft; a third differential gear connecting the third differential drive shaft with the third differential driven shaft by a differential gear structure; a fourth transfer gear connected to the third differential driven shaft by gear engagement; a second reverse gear connected to the fourth transfer gear by gear engagement; and a fourth fastening portion concentrically being disposed with the fourth transfer gear being connected to the second reverse gear by gear engagement and rotating to engage a bolt.

The torque input shaft, the first, second and third differential drive shafts, the first, second and third differential driven shafts, the first, second, third differential gears, the first, second, third and fourth transfer gears, and the first and second reverse gears may be provided in a gear box.

The bolt fastening apparatus further includes a torque input portion disposed external of the gear box to input a torque into the torque input shaft.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a bolt fastening apparatus according to an exemplary embodiment of the present invention.

FIG. 2 is a drawing showing that a gear box of a bolt fastening apparatus according to an exemplary embodiment of the present invention is incised.

FIG. 3 is a drawing showing that a gear box of a bolt fastening apparatus according to an exemplary embodiment of the present invention is omitted.

FIG. 4 is a drawing illustrating a gear connection structure of a bolt fastening apparatus according to an exemplary embodiment of the present invention.

It will be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawings.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

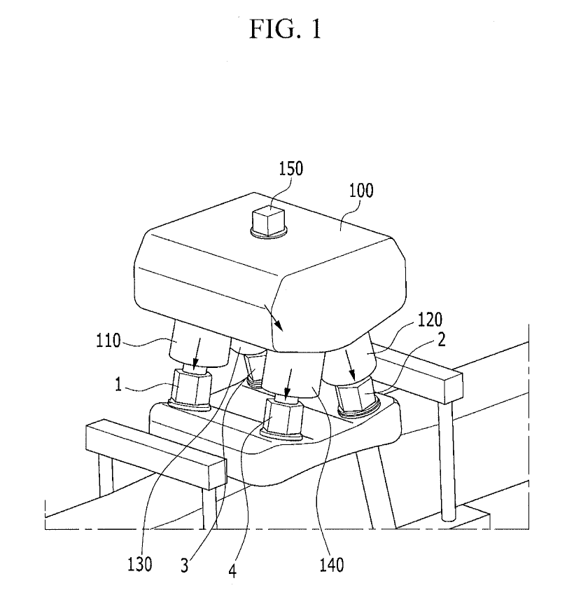

FIG. 1 is a perspective view of a bolt fastening apparatus according to an exemplary embodiment of the present invention.

As shown in FIG. 1, a bolt fastening apparatus according to an exemplary embodiment of the present invention includes a gear box 100, a torque input portion 150, a first fastening portion 110, a second fastening portion 120, a third fastening portion 130, and a fourth fastening portion 140.

Referring to FIG. 1, a bolt fastening apparatus according to an exemplary embodiment of the present invention engages nuts to a U-bolt for mounting a leaf spring to a vehicle, but it is not limited thereto. In addition, it is obvious to one skilled in the art that the bolt fastening apparatus is used to fasten bolts or nuts, and the bolt and the nut will be not distinguished and be represented by “bolt” in the description below.

The gear box 100 is a housing surrounding a gear connection structure to which a plurality of gears are connected according to an exemplary embodiment of the present invention.

The torque input portion 150 is disposed at an outside of the gear box 100 to transfer an input torque to a gear connection structure which is provided in the gear box 100. Herein, the input torque is a torque which is generated by a worker using a tool, and the tool has a type including an air pressure type, an electric type, and a manual type.

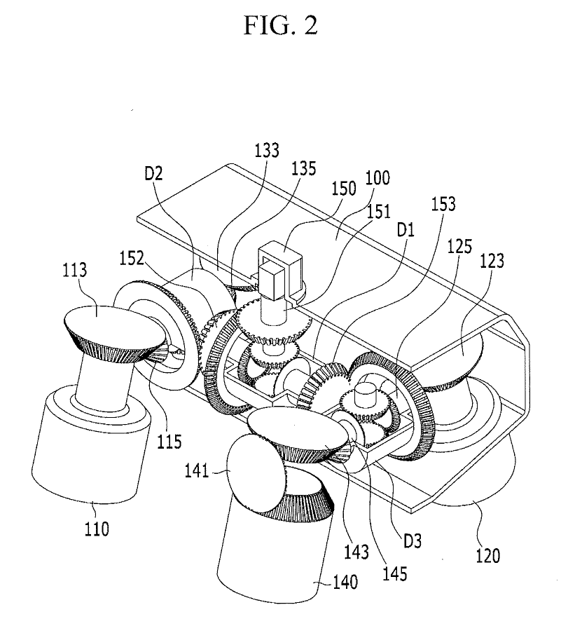

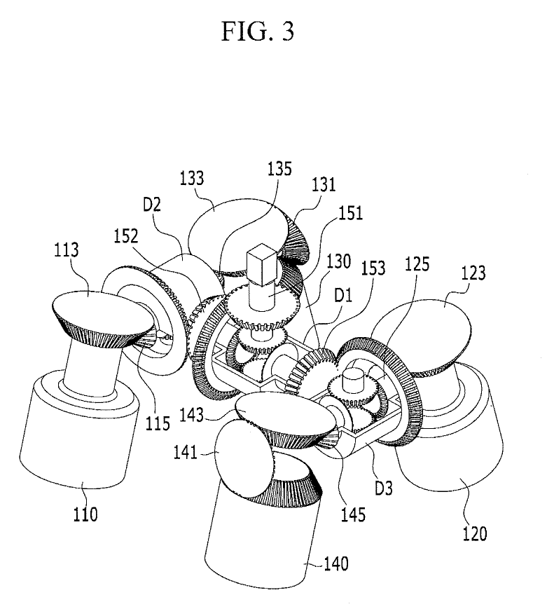

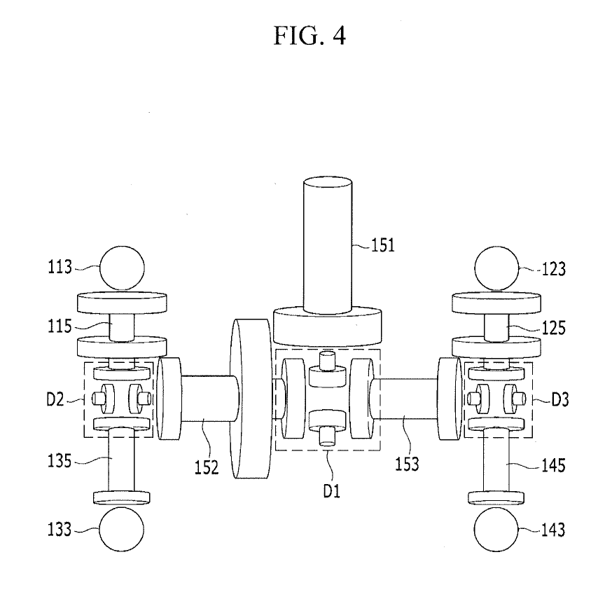

The first fastening portion 110 is connected to a first bolt 1 to engage the first bolt 1, and the second fastening portion 120 is connected to a second bolt 2 to engage the second bolt 2, and the third fastening portion 130 is connected to a third bolt 3 to engage the third bolt 3, and the fourth fastening portion 140 is connected to a fourth bolt 4 to engage the fourth bolt 4. Herein, the first bolt 1, second bolt 2, third bolt 3, and fourth bolt 4 are names for separating a plurality of bolts, and the bolt fastening apparatus according to an exemplary embodiment of the present invention can simultaneously engage at least two bolts. In FIG. 1, FIG. 2, FIG. 3, and FIG. 4, it is illustrated that the bolt fastening apparatus engages four bolts, but it is possible that more bolts are engaged by connecting a gear connection structure having the same concept.

FIG. 2 is a drawing showing that a gear box of a bolt fastening apparatus according to an exemplary embodiment of the present invention is incised, FIG. 3 is a drawing showing that a gear box of a bolt fastening apparatus according to an exemplary embodiment of the present invention is omitted, and FIG. 4 is a drawing illustrating a gear connection structure of a bolt fastening apparatus according to an exemplary embodiment of the present invention.

As shown in FIG. 2, FIG. 3 and to FIG. 4, the bolt fastening apparatus according to an exemplary embodiment of the present invention further includes, which are provided in the gear box 100, a torque input shaft 151, a first differential drive shaft 152, a first differential driven shaft 153, a first differential gear D1, a second differential drive shaft 115, a first transfer gear 113, a third differential drive shaft 125, a second transfer gear 123, a second differential driven shaft 135, a second differential gear D2, a third transfer gear 133, a first reverse gear 131, a third differential driven shaft 145, a third differential gear D3, a fourth transfer gear 143, and a second reverse gear 141.

The torque input shaft 151 integrally rotates together with the torque input portion 150 (Referring to FIG. 2).

The first differential drive shaft 152 is connected to the torque input shaft 151 by a bevel gear structure to rotate by directly receiving a torque of the torque input shaft 151. Herein, the bevel gear structure is well-known to a person of an ordinary skill in the art, so a detailed description thereof will be omitted.

The first differential driven shaft 153 dependently rotates by the rotation of the first differential drive shaft 152.

The first differential gear D1 has a structure of a general differential gear which is applied to an axle shaft for a vehicle and transfers a torque of the first differential drive shaft 152 to the first differential driven shaft 153. Herein, the structure of the differential gear is well-known to a person of an ordinary skill in the art, so a detailed description thereof will be omitted.

The second differential drive shaft 115 is connected to the first differential drive shaft 152 by a bevel gear structure to rotate by directly receiving a torque of the first differential drive shaft 152.

The first transfer gear 113 is connected to the second differential drive shaft 115 by gear engagement to rotate by directly receiving a torque of the second differential drive shaft 115. In addition, the first transfer gear 113 integrally rotates together with the first fastening portion 110. Meanwhile, an angle between a rotation center axis of the first transfer gear 113 and a rotation center axis of the second differential drive shaft 115 may be changed depending on a design of the gear engagement between the first transfer gear 113 and the second differential drive shaft 115 by a person of an ordinary skill in the art.

The third differential drive shaft 125 is connected to the first differential driven shaft 153 by a bevel gear structure to rotate by directly receiving a torque of the first differential driven shaft 153.

The second transfer gear 123 is connected to the third differential drive shaft 125 by gear engagement to rotate by directly receiving a torque of the third differential drive shaft 125. In addition, the second transfer gear 123 integrally rotates together with the second fastening portion 120. Meanwhile, an angle between a rotation center axis of the second transfer gear 123 and a rotation center axis of the third differential drive shaft 125 may be changed depending on a design of the gear engagement between the second transfer gear 123 and the third differential drive shaft 125 by a person of an ordinary skill in the art.

The second differential driven shaft 135 dependently rotates by the rotation of the second differential drive shaft 115.

The second differential gear D2 has a structure of a differential gear to be same to the first differential gear D1 and transfers a torque of the second differential drive shaft 115 to the second differential driven shaft 135.

The third transfer gear 133 is connected to the second differential driven shaft 135 by gear engagement to rotate by directly receiving a torque of the second differential driven shaft 135. In addition, the third transfer gear 133 is concentrically disposed with the third fastening portion 130. Meanwhile, an angle between a rotation center axis of the third transfer gear 133 and a rotation center axis of the second differential driven shaft 135 may be changed depending on a design of the gear engagement between the third transfer gear 133 and the second differential driven shaft 135 by a person of an ordinary skill in the art.

The first reverse gear 131 is connected to the third transfer gear 133 and the third fastening portion 130 by a bevel gear structure. Thus, the first reverse gear 131 functions wherein the third transfer gear 133 and the third fastening portion 130 rotate on the contrary to each other.

The third differential driven shaft 145 dependently rotates by the rotation of the third differential drive shaft 125.

The third differential gear D3 has a structure of a differential gear to be same to the first differential gear D1 and transfers a torque of the third differential drive shaft 125 to the third differential driven shaft 145.

The fourth transfer gear 143 is connected to the third differential driven shaft 145 by gear engagement to rotate by directly receiving a torque of the third differential driven shaft 145. In addition, the fourth transfer gear 143 is concentrically disposed with the fourth fastening portion 140. Meanwhile, an angle between a rotation center axis of the fourth transfer gear 143 and a rotation center axis of the third differential driven shaft 145 may be changed depending on a design of the gear engagement between the fourth transfer gear 143 and the third differential driven shaft 145 by a person of an ordinary skill in the art.

The second reverse gear 141 is connected to the fourth transfer gear 143 and the fourth fastening portion 140 by a bevel gear structure. Thus, the second reverse gear 141 functions wherein the fourth transfer gear 143 and the fourth fastening portion 140 rotate on the contrary to each other.

According to an exemplary embodiment of the present invention, as the differential gear structures D1, D2, and D3 are applied, uniform torque distribution can be achieved and at least two bolts 1, 2, 3, and 4 can be engaged without fail by varying rotation speeds of fastening portions 110, 120, 130, and 140 depending on deviation of the time that fastening bolts 1, 2, 3, and 4 are completed. Therefore, an assembly tolerance may be ultimately decreased. In addition, work may be possible without limitation about a work site as a torque is mechanically transferred by applying differential gear structures D1, D2, and D3.

For convenience in explanation and accurate definition in the appended claims, the terms “upper”, “lower”, “internal”, “outer”, “up”, “down”, “upwards”, “downwards”, “front”, “rear”, “back”, “inside”, “outside”, “inwardly”, “outwardly”, “internal”, “external”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A bolt fastening apparatus comprising:
a torque input shaft into which a torque is inputted;
a first differential drive shaft connected to the torque input shaft by a bevel gear structure;
a second differential drive shaft connected to the first differential drive shaft by a bevel gear structure;
a first transfer gear connected to the second differential drive shaft by a gear engagement;
a first fastening portion connected to a bolt to engage the bolt by integrally rotating together with the first transfer gear;
a first differential driven shaft connected to the first differential drive shaft by a differential gear structure;
a third differential drive shaft connected to the first differential driven shaft by a bevel gear structure;
a second transfer gear connected to the third differential drive shaft by a gear engagement; and
a second fastening portion connected to a bolt to engage the bolt by integrally rotating together with the second transfer gear.

2. The bolt fastening apparatus of claim 1, further including:
a second differential driven shaft connected to the second differential drive shaft by a differential gear structure;
a third transfer gear connected to the second differential driven shaft by a gear engagement;
a third fastening portion concentrically disposed with the third transfer gear and connected to a bolt to engage the bolt; and
a first reverse gear connected to the third transfer gear and the third fastening portion by a bevel gear structure.

3. The bolt fastening apparatus of claim 2, further including:
a third differential driven shaft connected to the third differential drive shaft by a differential gear structure;
a fourth transfer gear connected to the third differential driven shaft by a gear engagement;
a fourth fastening portion concentrically disposed the fourth transfer gear and connected to a bolt to engage the bolt; and
a second reverse gear connected to the fourth transfer gear and the fourth fastening portion by a bevel gear structure.

4. The bolt fastening apparatus of claim 3, wherein the torque input shaft, the first differential drive shaft, the first differential driven shaft, the second differential drive shaft, the first transfer gear, the third differential drive shaft, the second transfer gear, the second differential driven shaft, the third transfer gear, the first reverse gear, the third differential driven shaft, the fourth transfer gear, and the second reverse gear are provided in a gear box, and a torque input portion is disposed at an outside of the gear box to input a torque into the torque input shaft.

5. A bolt fastening apparatus comprising:
a torque input shaft into which a torque is inputted;
a first differential drive shaft connected to the torque input shaft by a gear engagement;
a second differential drive shaft connected to the first differential drive shaft by a gear engagement;
a first transfer gear connected to the second differential drive shaft by a gear engagement;
a first fastening portion rotating together with the first transfer gear to engage a bolt;
a first differential driven shaft dependently rotating by a rotation of the first differential drive shaft;
a first differential gear connecting the first differential drive shaft with the first differential driven shaft by a differential gear structure;
a third differential drive shaft connected to the first differential driven shaft by a gear engagement;
a second transfer gear connected to the third differential drive shaft by a gear engagement; and
a second fastening portion rotating together with the second transfer gear to engage a bolt.

6. The bolt fastening apparatus of claim 5, further including:
a second differential driven shaft dependently rotating by a rotation of the second differential drive shaft;
a second differential gear connecting the second differential drive shaft with the second differential driven shaft by a differential gear structure;
a third transfer gear connected to the second differential driven shaft by a gear engagement;
a first reverse gear connected to the third transfer gear by a gear engagement; and
a third fastening portion concentrically being disposed with the third transfer gear, and being connected to the first reverse gear by a gear engagement, and rotating to engage a bolt.

7. The bolt fastening apparatus of claim 6, further including:
a third differential driven shaft dependently rotating by a rotation of the third differential drive shaft;
a third differential gear connecting the third differential drive shaft with the third differential driven shaft by a differential gear structure;
a fourth transfer gear connected to the third differential driven shaft by a gear engagement;
a second reverse gear connected to the fourth transfer gear by a gear engagement; and
a fourth fastening portion concentrically being disposed with the fourth transfer gear, and being connected to the second reverse gear by a gear engagement, and rotating to engage a bolt.

8. The bolt fastening apparatus of claim 7, wherein the torque input shaft, the first, second and third differential drive shafts, the first, second and third differential driven shafts, the first, second, third differential gears, the first, second, third and fourth transfer gears, and the first and second reverse gears are provided in a gear box, and a torque input portion is disposed at an outside of the gear box to input a torque into the torque input shaft.
